(19) United States
(12) Patent Application Publication
(10) Pub. No.: US 2026/0141565 A1
(43) Pub. Date: May 21, 2026

(54) DATA-PARALLEL DECOMPRESSION OF DENSE GEOMETRY FORMAT TRIANGLE MESHES

(71) Applicant: Advanced Micro Devices, Inc., Santa Clara, CA (US)

(72) Inventor: Quirin Nikolaus Meyer, Munich (DE)

(73) Assignee: Advanced Micro Devices, Inc., Santa Clara, CA (US)

(21) Appl. No.: 18/949,417

(22) Filed: Nov. 15, 2024

(51) Int. Cl. G06T 9/00

(52) U.S. Cl. CPC G06T 9/001

(57) ABSTRACT

Rendering 3D geometry involves processing a very large amount of geometry. Compression techniques can be used to decrease the amount of data required for such geometry overall. A particular compression format for geometry is dense compression format, in which triangle strips are represented in highly compacted code sequences. In particular, compression code sequences describe the connectivity between triangles of a strip, thus ultimately provide a compact representation of which vertex indices comprise each triangle. A vertex index is an index into a vertex buffer that stores the actual vertex data, allowing for deduplication of such data. Though compact, such compression code sequences are somewhat tricky to decompress. A technique is provided herein for decompressing such code sequences. In particular, the technique involves a series of bitwise, arithmetic, and/or logical operations that expand out the code sequences into indices for the triangles.

### BACKGROUND

Graphics rendering involves processing a high amount of geometry. Compression helps reduce the amount of data required at the expense of extra processing.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a block diagram illustrating a graphics processing pipeline, according to an example;

FIG. 4 illustrates a compression scheme for compressed geometry;

FIG. 5A illustrates a topology decompression system, according to an example;

FIG. 5B illustrates a vertex generation system, according to an example;

FIG. 6 is a flow diagram of a method for decompressing data of a compressed topology block to obtain a set of vertex indices defining a triangle, according to an example;

FIG. 7 illustrates a set of operations for decompressing compressed topology, according to an example; and

FIG. 8 illustrates a set of operations for decompressing compressed topology, according to another example.

### DETAILED DESCRIPTION

Rendering 3D geometry involves processing a very large amount of geometry. Compression techniques can be used to decrease the amount of data required for such geometry overall. A particular compression format for geometry is dense geometry format, in which triangle strips are represented in highly compacted code sequences. In particular, compression code sequences describe the connectivity between triangles of a strip, thus ultimately providing a compact representation of which vertex indices comprise each triangle. A vertex index is an index into a vertex buffer that stores the actual vertex data, allowing for deduplication of such data.

Though compact, such compression code sequences are somewhat tricky to decompress. Techniques are provided herein for decompressing such code sequences. In particular, the techniques involves a series of bitwise, arithmetic, and/or logical operations that expand out the code sequences into indices for the triangles in a highly efficient and parallelized manner.

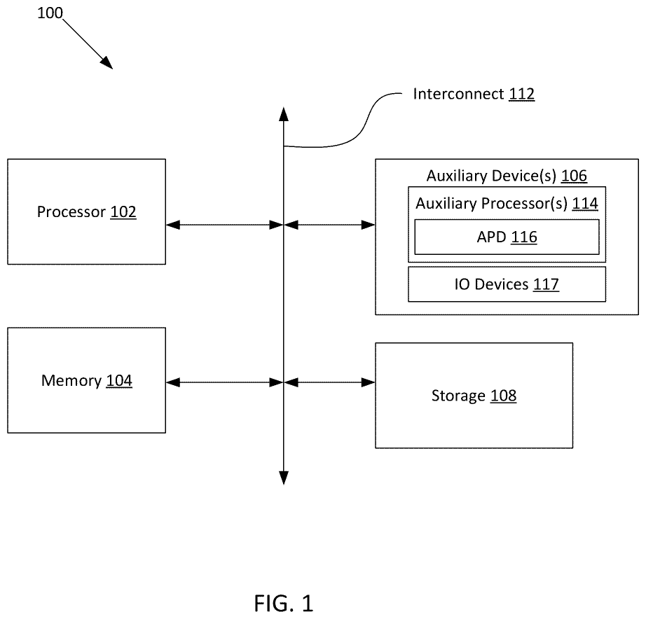

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with, for example, a single-instruction-multiple-data (“SIMD”) or a single-instruction-multiple-thread (“SIMT”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

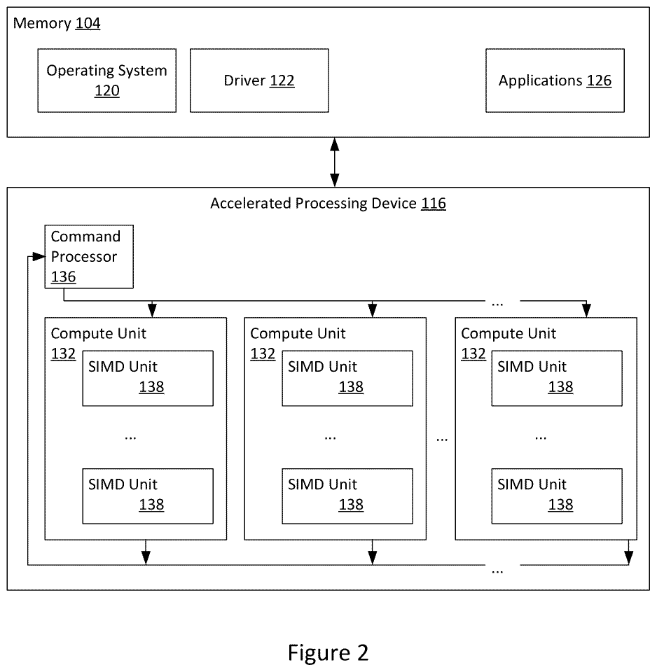

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen, thirty-two or sixty-four lanes, where each lane executes the same instruction at the same time as the other lanes in the parallel processing unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps. One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A command processor 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

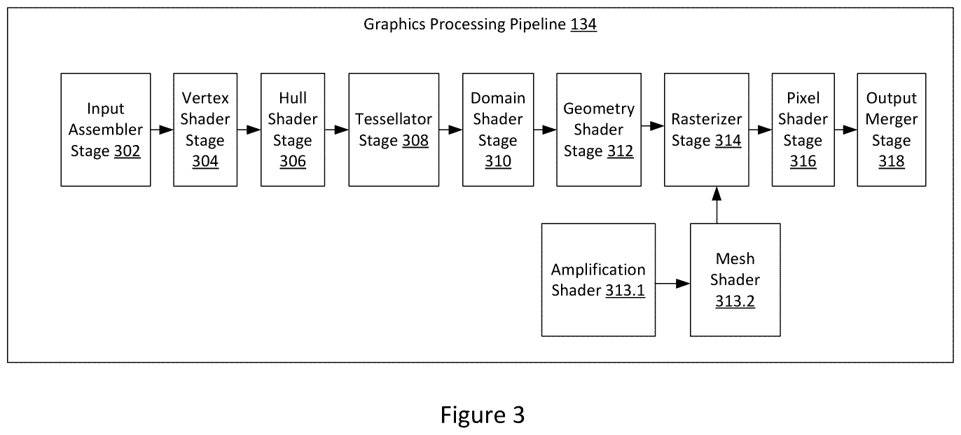

FIG. 3 is a block diagram showing additional details of the graphics processing pipeline 134 illustrated in FIG. 2. The graphics processing pipeline 134 includes logical stages that each performs specific functionality. The stages represent subdivisions of functionality of the graphics processing pipeline 134. Each stage is implemented partially or fully as shader programs executing in the programmable processing units 202, or partially or fully as fixed-function, non-programmable hardware external to the programmable processing units 202.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertexes of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations. Herein, such transformations are considered to modify the coordinates or “position” of the vertices on which the transforms are performed. Other operations of the vertex shader stage 304 modify attributes other than the coordinates.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the programmable processing units 202.

The geometry shader stage 312 performs vertex operations on a primitive-by-primitive basis. A variety of different types of operations can be performed by the geometry shader stage 312, including operations such as point sprint expansion, dynamic particle system operations, fur-fin generation, shadow volume generation, single pass render-to-cubemap, per-primitive material swapping, and per-primitive material setup. In some instances, a shader program that executes on the programmable processing units 202 perform operations for the geometry shader stage 312.

In some examples, an amplification shader stage 313.1 and a mesh shader stage 313.2 are present. In some examples, a mesh shader stage 313.2 acts as a bypass entry point for the pipeline 134, allowing user-defined geometry to be directly provided to the rasterizer stage 314 and subsequent stages without having to be processed through the previous stages. An amplification shader stage 313.2 controls how work is launched on the mesh shader stage 313.2. In some examples, the amplification shader is optional.

The rasterizer stage 314 accepts and rasterizes simple primitives and generated upstream. Rasterization includes determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a shader program that executes on the programmable processing units 202.

The output merger stage 318 accepts output from the pixel shader stage 316 and merges those outputs, performing operations such as z-testing and alpha blending to determine the final color for a screen pixel.

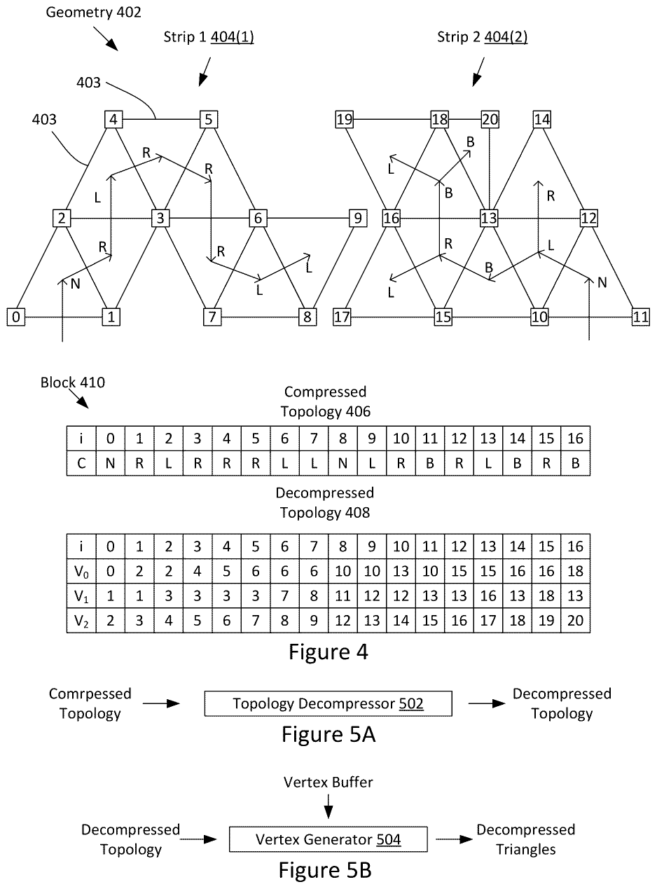

As just described, the graphics processing pipeline 134 processes geometric data to generate an image. FIG. 4 illustrates a compression scheme for compressed geometry. In particular, FIG. 4 illustrates geometry 402, which includes a plurality of triangles 403 defined by vertices (numbered 0 through 20 in FIG. 4). These triangles 403 are formed into strips 404. Triangles in a strip 404 share at least some vertices with other triangles. Two separate strips 404 are illustrated in the geometry 402.

Geometry is typically represented as a set of indices into a vertex buffer, where the vertex buffer defines the vertex coordinates for a unique set of vertices. This configuration prevents duplication of vertex data where vertices are reused. For example, a vertex used in three different triangles can be represented as three instances of an index along with a single set of vertex coordinates, rather than a set of vertex coordinates duplicated three times.

In the compression scheme of FIG. 4, the “topology” of geometry - the set of indices that comprises each of a set of triangles—is, itself, compressed. This compressed topology represents a series of triangles with a set of codes (sometimes “compression codes”)—N, R, L, and B. The N code is a “new strip code” and signifies a new triangle strip. A triangle having the “N” code is sometimes referred to herein as a “reset triangle.” The “R” is a “right turn code” and signifies that the next triangle is formed by taking a “right turn” with respect to the previous code. Similarly, the “L” is a “left turn code” and signifies that the next triangle is formed by taking a “left turn” with respect to the previous code. The “B” is a “back track code” and signifies that the next triangle is formed by backtracking to the previous triangle and then taking the “other” direction. In other words, if the current triangle was arrived at with an “R” code from a previous triangle, then a subsequent “B” code would back track to the previous triangle and would form a new triangle as if an “L” code were present.

Each code of a compressed block 410 defines which indices comprise a triangle corresponding to that code. Further, each code has an index that describes the position of the code in the compressed block 410. A block 410 begins with an N code, indicating a new strip. This triangle is formed from the first three vertices. In fact, any time an N code occurs in the compressed block 410, the triangle for that N code is formed from the next three indices in the block 410 after the last index used by all previous triangles. For example, if indices 0-11 are used for triangles and then an N code occurs, then the triangle for that N code is formed from indices 12, 13, and 14.

The R and L codes form a triangle from two of the indices of the previous triangle in the block 410 (e.g., the triangle corresponding to the code immediately prior to the R or L code in the block 410), as well as a subsequent index. The selection of which vertices from the previous triangle are included for the triangle for the R and L code is dependent on whether the code is R or L. For an R code, the indices used are the indices that form the right edge, from the perspective of the entry edge to the previous triangle. Similarly, for an L code, the indices used are the indices that form the left edge, from the perspective of the entry edge to the previous triangle. The “entry edge” to the previous triangle is the edge that is shared with the triangle previous to that triangle, or for the case of an “N” code, is the edge formed by the two lowest numbered indices of the new triangle.

In the example of FIG. 4, a first triangle, corresponding to code 0 (“N”) is formed by indices 0, 1, and 2 (where these indices are illustrated with numbered boxes at the vertices of the triangles in the geometry 402. The “entry edge” for triangle 0 is edge 0-1. The entry edge into triangle 0 is shown with an arrow through that edge terminating with the “N” code. The next code, for triangle 1, is an R code. Therefore, the next triangle is formed from a new index—index 3, along with the indices that form the “right edge” of the previous triangle—triangle 0. These indices are 1 and 2. As can be seen, this is the “right edge” from the perspective of the entry edge—edge 0, 1. “L” would be the edge 0, 2. Subsequent triangles are formed in a similar manner. Triangle 2 is formed using an L code, meaning that this triangle is formed with the left edge—edge 2, 3, and new index 4. The R for triangle 3 means that this triangle is formed with the right edge—5, 3, and new index 6. Triangles 4-7 are formed in a similar manner. Triangle 8 corresponds to an “N” code, meaning that this triangle is formed from three subsequent indices 10, 11, and 12. Triangles 9 and 10 are formed with L and R codes, as shown. Triangle 11 is formed with a B code, meaning that the sequence back tracks to triangle 9 and then takes the “other” path. More specifically, from triangle 9 to triangle 10, the R path was taken. Thus, the B code for triangle 11 is formed by taking the “L” path from triangle 9. The remaining triangles illustrated are formed in a similar manner as shown.

As can be seen, a sequence of short codes can be used to describe triangle strips in a highly compressed manner. Because there are only four possible codes, each triangle can be represented with 2 bits, meaning that a block of 16 triangles (for example) can be represented as 32 bits, and a block of 32 triangles (for example) can be represented as 64 bits.

The decompressed topology 408 indicates the vertex indices for each of triangles 0-16. V₀ is the first vertex index for a triangle, V₁ is the second, and V₂ is the third. These vertex indices are derivable from the compressed topology 406 as described above. As can be seen, a great deal of space is saved by representing each triangle as one of the codes as compared with representing it with one or more vertex indices.

FIG. 5A illustrates a topology decompression system, according to an example. The topology decompression system includes a topology decompressor 502, which receives the compressed topology and generates decompressed topology. In various examples, the topology decompressor 502 includes software executable on a processor such as the processor 102 or the APD 116, hardware such as digital circuitry configured to perform the operations of the topology decompressor 502, or a combination thereof. In some example, at least some of the software operations of the software executable trigger operations performed by specialized execution hardware realized in digital circuitry.

The topology decompressor 502 is configured to generate decompressed topology 408 from compressed topology 406. In particular, the topology decompressor 502 accepts the sequence of codes that comprise a compressed topology 406 and generates vertex indices for one or more of the triangles of the compressed topology 406.

FIG. 5B illustrates a vertex generation system, according to an example. The vertex generation system includes a vertex generator 504 which can be implemented as software executable on a processor such as the processor 102 or the APD 116, as hardware such as digital circuitry configured to perform the operations of the topology decompressor 502, or a combination thereof. In some example, at least some of the software operations of the software executable trigger operations performed by specialized execution hardware realized in digital circuitry. In some examples, the vertex generator 504 includes fixed function hardware that performs some of the operations of the input assembler stage 302.

In operation, the vertex generator 504 performs a lookup in the vertex buffer using the indices of the decompressed topology 408 to obtain vertex data for the triangles. More specifically, given a vertex index, the vertex generator 504 looks up the vertex data at that index, within the vertex buffer. For a triangle, the vertex generator 504 obtains three instances of such vertex data in a similar manner, using the vertex indices defined by the decompressed topology 408 for that triangle.

Regarding decompression, it is sometimes desirable to obtain triangle data in a “random access manner”—that is, it is sometimes desirable to obtain the triangle data, including the indices and then the vertices, of one triangle in a compressed block 410, without needing to decompress any or all of the other triangles in that block. In an naive implementation, such an operation can be somewhat time consuming, since the compression codes are not independent and rely on previous information. Thus, such a naive implementation might traverse the entire set of compression codes in a block of compressed topology in order to generate the vertex indices for a triangle having a particular triangle index (where the triangle indices are shown in the top row of the compressed topology 406 of FIG. 4). This is relatively slow. A different technique is therefore provided herein.

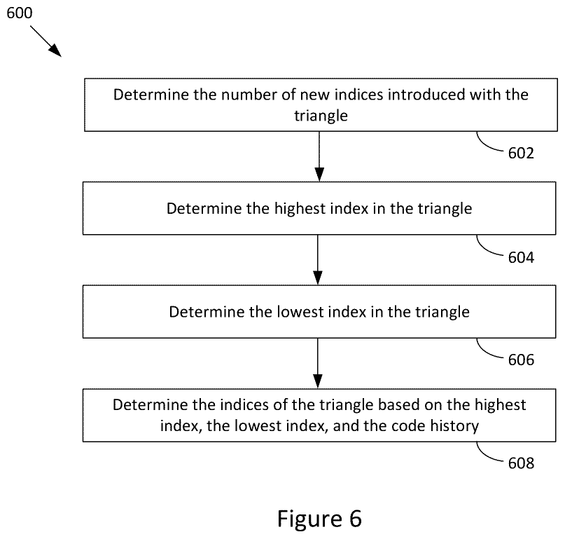

FIG. 6 is a flow diagram of a method 600 for decompressing data of a compressed topology block 410 to obtain a set of vertex indices defining a triangle, according to an example. Although described with respect to the system of FIGS. 1-5B, those of skill in the art will understand that any system configured to perform the steps of the method 600 in any technically feasible order, falls within the scope of the present disclosure. In some examples, the method 600 is performed in a compute shader stage prior to the pipeline 134, and in other examples, the method 600 is performed by the mesh shader stage 313.2, with an optional amplification shader stage 313.1.

The goal of the method 600 is to determine which indices are assigned to a given triangle. As shown in FIG. 4, each triangle index (top row, labeled “i” for “index,” in compressed topology 406 and in decompressed topology 408) is associated with a set of vertex indices, which are in rows labeled V₀, V₁, and V₂. The method 600 decompresses a triangle having a given triangle index (e.g., 0 through 16 in the example of FIG. 4) to generate the vertex indices for that triangle. The method thus begins with code values for each triangle in a compressed block.

At step 602, the topology decompressor 502 determines the number of new indices introduced with the triangle. More specifically, each triangle introduces either one new index or three new indices. For a triangle that continues the strip, the triangle is connected to an edge of that strip and thus reuses two already existing vertices. Thus, for a triangle represented with any code other than the reset code (“N”), that triangle introduces one new index and for a triangle represented with the reset code, that triangle introduces three new indices.

At step 604, the topology decompressor 502 determines the highest index for the new triangle. This index is always V₂ for the triangle. In addition, the highest index for the new triangle is always the highest index of the previous triangle plus the number of indices introduced by the new triangle (e.g., for a new triangle having index i, if triangle having index i-1 has a highest vertex index of 5, and the new triangle introduces one new vertex, then the new triangle has a highest vertex index of 6).

At step 606, the topology decompressor 502 determines the lowest index in the triangle. This is the lowest numerical index for that triangle. At step 608, the topology decompressor 502 determines all of the indices for the triangle based on the determined highest and lowest indices and based on the code history. The “code history” includes the triangle codes (e.g., codes 702(1)) for one or more triangles including the triangle being analyzed. The word “history” in this term accounts for the fact that what is considered includes the code for that triangle as well as previous triangles (e.g., virtual previous code 702(2.1).

The operations of FIG. 6 generate decompressed triangles as described. Specific example implementations of these operations are now discussed.

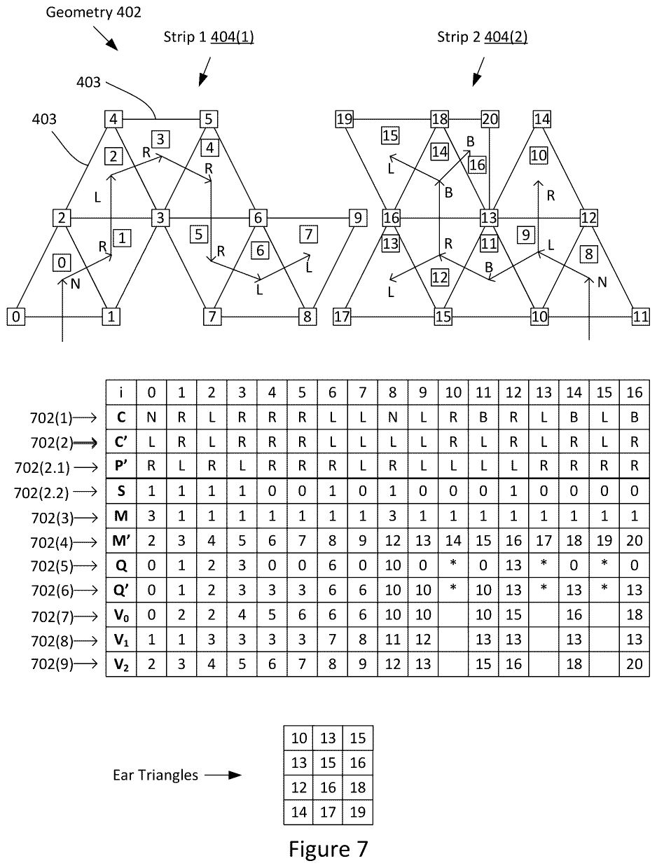

FIG. 7 illustrates a set of operations for decompressing compressed topology 406, according to an example. These operations include calculating a plurality of data sets 702, where each data set 702 includes a data element for a plurality of triangles included in the compressed topology 406. A code data set 702(1) is the compressed topology 406 and comprises the input to the topology decompressor 502. Data sets 702(7), 702(8), and 702(9) are the vertex indices being decompressed. Each step of the method 600 corresponds to one or more data sets 702.

In particular, step 602 involves calculating data set 702(3), referred to as “M.” In particular, this calculation is performed by setting the value to 3 if the triangle has a reset code (“N”), and setting the value to 1 if the triangle has any other code (“R,” “L,” or “B”). This is because a new triangle introduces 3 new indices, while any other triangle shares an edge (and thus 2 vertices) with another triangle that already exists.

Regarding step 604, which is to determine the highest index in the triangle, in the example of FIG. 7, this operation is performed by determining the data set 702(4)-“M′.” To determine this data set, the topology decompressor 502 performs a running sum that adds the M value for the current triangle to the M′ value for the immediately previous triangle (with an imaginary −1 value for the M′ value for the triangle immediately previous to triangle 0). Thus, the M′ value for triangle 0 is −1+3=2. The next is 2+1 =3. As the M value through triangle 7 is 1, this amount is added to each subsequent triangle until the next N code, which adds 3. Conceptually, this makes sense—the highest index for a new triangle will be the highest index in the immediately previous triangle plus the number of indices added by the new triangle. Once this value is determined, this value is set as the index V₂ for the triangle, as shown. In some examples, calculating the M′ data set is performed as a summation operation that iteratively sums the M value of the triangle with the immediately M′ value for the immediately previous triangle. In some examples, this is performed as an inclusive scan operation, which has O(log(n)) time complexity. In some examples, for speed, each data set 702 is included within a single register, which is possible due to the limited range of values for each element in the data set (e.g., the codes can be represented each with 2 bits, and the other values have a limited set of values as well). Thus, a hardware supported instruction that performs, for example, the inclusive scan, can be used to achieve O(log(n)) time complexity.

Regarding step 606, this step involves determining the lowest numbered index of the triangle. In particular, this step involves calculating the Q and Q′ data sets 702, where the Q′ data set 702(6) indicates the lowest numbered index and the Q data set 702(5) includes helper values for calculating Q′.

It should be understood that so-called “ear triangles” are handled in a special way. In particular, these triangles are skipped for the purpose of step 604, and will be handled as special cases in subsequent operations. For this reason, no Q or Q′ values are generated for ear triangles (marked with a “*” in FIG. 7). In addition, step 604 also includes calculating “virtual codes” for each triangle that has either an “N” (reset) code, or a backtrack (“R”) code, and for each triangle immediately before a triangle with a backtrack (“R”) code. (Triangles immediately before a triangle with a backtrack code are referred to as “ear triangles” herein and this is marked with an “E” in the virtual codes data set 702(2)-C′.).

To calculate Q for a triangle, the topology decompressor 502 performs the following operations. First, if the code for the triangle is “N”—a reset code (where triangles having the reset code “N” are sometimes referred to herein as “reset triangles”), then Q for the triangle is equal to M′ for the triangle−2. In particular, since M′ is the last index for the triangle, and because a reset triangle has three new indices, the Q value, which is related to the lowest index for the triangle, is M′−2. If the code for the triangle is not “N,” then the value of Q for the triangle depends on whether, for the triangle, a “code switch” is considered to have occurred. If no code switch has occurred, then Q for that triangle is 0. If a code switch has occurred, then Q is set to a value dependent on M′. More particularly: a code switch is considered to have occurred if the code (or virtual code if available) for the triangle is different than the previous code. The “code or virtual code” is L or R if the code is L or R for the triangle, and, if not, is the value in the C′ data set otherwise. This virtual code value is L for triangles with reset codes (“N”). Moreover, if the code for the triangle is B (backtrack), then the virtual code for that triangle is the “opposite” (L if R or R if L) of the code of the immediately previous triangle. For example, triangle 11 has a backtrack code and because triangle 10's code is R, the virtual code for triangle 11 is L.

Referring back to the “code switch,” a code switch occurs if the virtual code of the triangle is opposite the virtual code of the “previous triangle.” In this context, the previous triangle means the immediately previous triangle, unless the immediately previous triangle is an ear triangle. In that case, the previous triangle is the triangle immediately prior to that ear triangle.

Values C′ 702(2.1) (“virtual code”) and P′ 702(2.2) (“virtual previous code”) are helper values for calculating Q. For C′, C′[i]=C[i] if C[i] is L or R (note that the notation [x] indicates the x'th element of a value such as C′ or P′—for example, C[5] is the 5^{th} element of C, which is “R”). If C[i]=B, then C′[i] is the “opposite” (or “inverted”) code of the previous triangle (e.g., if C[i]=B, then C′[i]=opposite(C[i-1])). For example, since C[11] is B, C′[11] is the opposite of C[10] (which is R), and thus C′[11] is L. For a backtrack code, this is treated as if “the other” path had been taken, from the perspective of two triangles ago. In other words, from the perspective of i-2, if i-1 was an “L” code and i is a “B” code, then the i is treated as if it took an “R” code from triangle i-2. If C[i]=N, then C′[i] =L.

For P′, if C[i]=L or R, then P′[i]=C′[i]. If C[i]=N, then C′[i] =L. If C[i] =B, and C[i-2] is not B, then P′[i]=C[i-2] (this is because if C[i]=B, then i-1 is an ear triangle, so the “previous” triangle is considered to be the triangle before the ear triangle). However, if C[i]=B and C[i-2] is also B, then clearly, P′[i] cannot be C[i-2]. Instead, the inverse (“opposite”) of C[i-3] is used as P′[i]. Note that it's possible for the indices to C to become negative, in which case these indices are clamped to 0 when accessing C and C′ (in other words, if i-2=−1, then it just becomes i-1, which is 0.

S[i] is marked as a 0 if C′[i]=P′[i], as this indicates there has not been a code change. S[i] is marked as a 1 if C′[i]!=P′[i], as this indicates that there has been a code change. If there is not a code change (i.e., S[i]=0), then Q[i]=0. If there is a code change, then then Q[i]=M′[i]−2, unless: (1) C[i]=B and C[i-2]!=B, in which case Q[i]=M′[i]−3; (2) C[i]=B and C[i-2]=B, in which case Q[i]=M′[i]−4; or (3) C[i]!=N and C[i-1]=B, in which case Q[i]=M′[i]−3.

Next, Q′ for each triangle is calculated as the maximum of the Q′ value for the immediately previous triangle and the Q value for that triangle. As can be seen, the Q′ values are propagated as described above. In some examples, this maximum value is obtained by iteratively scanning through the Q and Q′ values, starting with triangle 0 and continuing to the end of the compressed topology block 406.

Conceptually, Q stores either a new lowest index, which occurs if a code change occurs, or a 0, which is an indication that the previous lowest index should be used. More specifically, when a code change does not occur between two triangles, the latter triangle “pivots” around a vertex and thus uses the same lowest numbered index as the previous triangle. For example, triangle 4 uses an R code, as does triangle 3. Thus, a code change does not occur as triangle 4 “pivots” around the lowest index of triangle 3—index 3. This is similar as well for triangle 5, which continues that pivot, but when a code change occurs for triangle 6, the pivot does not occur around the lowest index.

Conceptually, Q′ for a triangle stores the actual lowest index for that triangle. This value converts the “0's” of Q to the value of the highest seen lowest index. For example, for triangles 4 and 5, which have a Q of 0, the most recently seen Q′ value is 3. This value reflects the pivot around that lowest index that occurs for the lack of code change.

Finally, vertices V0 and V1 are calculated based on the above values—this is step 608. In particular, the following rules are applied:

If the code for the triangle is “L,” then V1 for that triangle=V2 for that triangle−1. If the code for the triangle is “B” and the virtual code is “L”, then V1 for that triangle=V2 for that triangle−2. If the code for the triangle is “R,” then V0 for the triangle=V2 for that triangle−1. If the code is B and the virtual code is R, then V0 for the triangle=V2 for that triangle−2. As can be seen, this operation sets one of V0 or V1 for the triangle, depending on the code. As Q′ stores the lowest index for a triangle, the index not set for a triangle (V0 if V1 has been set or V1 if V0 has been set) is assigned the value in Q′ for that triangle. In the illustrated example, for triangle 7, the code is L and thus V1=V2−1 (that is, 9−1=9). V0 thus is assigned Q′ for triangle 7, which is 6. In another example, for triangle 11, the code is B and the virtual code is L, and thus V1=V2−2 (thus 15−2=13). V0 thus is assigned Q′ for triangle 11, which is 10. This operation for determining Q′ reflects the idea that Q′ stores the lowest index, and this is assigned to either V0 or V1 depending on the code. The other index is dependent on V2 and on whether the code is B or one of R and L.

Regarding the ear triangles, these triangles are determined as a special case in the following manner. If the ear triangle has an “L” code, then V0 and V1 are the lowest and highest indices of the immediately previous triangle, and V2 is V2 of the immediately previous triangle+1. If the ear triangle has an “R” code, then V0 and V1 are the highest two indices of the immediately previous triangle, and V2 is V2 of the immediately previous triangle+1.

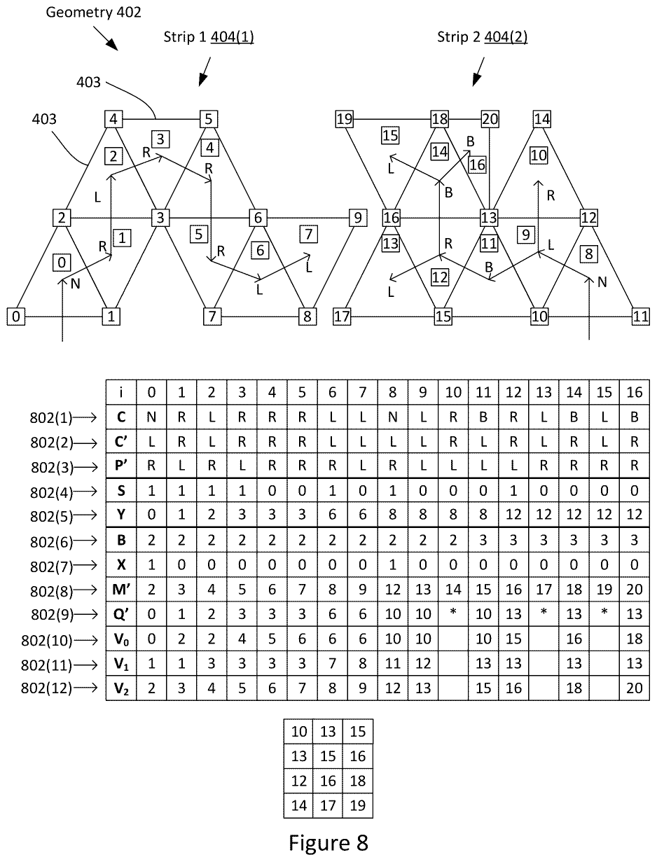

It should be noted that calculating M′ and Q′ are relatively time-consuming, as they require iteration through elements of the data sets 702. FIG. 8 illustrates a technique for calculating M′ and Q′ in O(1) time, according to an example.

In this technique, as with the technique of FIG. 7, the topology decompressor 502 generates a set of data sets 802. Some of these data sets—notably M′ and Q′—are the same as in FIG. 7, but others are different or in addition to those of FIG. 7, and M and Q are not calculated in the technique of FIG. 8. Importantly, in the technique of FIG. 8, the topology decompressor 502 calculates additional values, represented by P′, S, Y, B, and X, in order to calculate M′ and Q′ with O(1) time-complexity, rather than the O(log(n)) time-complexity associated with the scanning operation described above. Additional details follow.

Regarding C′, this value is calculated as follows. If the code (C) for a triangle is a backtrack code (“B”), then C′ is the opposite code of the previous triangle (the ear triangle). If the code (C) for a triangle is a reset code (“N”), then C′ is L. If the code (C) is neither B nor N, then C′ for a triangle is the same as C for the triangle.

Regarding P′, this value is set as follows. If the code C for the triangle is a reset code (“N”), then P′ for that triangle is R. Otherwise, if the code C is not a backtrack code, then P′ is the code C of the immediately previous triangle. Otherwise, if the code C is a backtrack code, then P′ is the code C of the triangle immediately prior to the immediately prior ear triangle. Note that ear triangles do not participate in this. P′ is the “virtual previous code,” meaning that it is the code of the previous triangle, with two exceptions: this “previousness” skips ear triangles, and reset triangles always receive an “R.”

Regarding S, this is the “code change” value that indicates whether a code change occurs. In particular, if P′ and C′—the “virtual previous” and “virtual code” are different (L/R or R/L), then a code change occurs and S gets a value of “1” (which indicates yes). However, if the code C for the immediately subsequent triangle is a backtrack code, then the triangle gets a value of 0. In the examples illustrated, it can be seen that triangles 0-3 have code changes (as their C′ and P′ are different), but 4 and 5 do not. Triangles 6, 8, and 12 also have code changes, where the rest (including the ear triangles 10, 13, and 15) do not.

Regarding Y, this is a helper value for calculating Q′. In particular, for any given triangle T, Y for that triangle represents the triangle index that is the last triangle index indicated as having a code change in S. In other words, the Y value for a triangle T considers all values in S up to triangle T. The index of the triangle in S, up to triangle T, that is the last triangle that has a code change, is the value set in Y. In the example, for each of triangles 0 to 3, the Y value for that triangle is the index of that triangle. That is because that is the last triangle up to that triangle for which S is a “1”.

Regarding B, this value can take three possible values: 2, 3, or 4. B[i]=4 if C[i]=B and C[i-2]=B. B[i]=3 if C[i]=B and C[i-2] is not B. B[i] is also 3 if C[i] is not N and B[i-1] is B. And in all other cases, B[i]=2.

Regarding X, this value is simply an indication of whether the triangle is a reset triangle—thus, this value is 1 if it is a reset triangle and a 0 otherwise.

Calculating M′ occurs in the following manner. To calculate M′ for a triangle, first, the number of reset indicators in X, up to the triangle. This operation can be performed speedily if X is represented as a single value in a register, with the indicator for each triangle represented as a bit in that single value. Then, an instruction such as “population count” can be used to determine the number of indicators in constant time. In particular, the overall value in X is bitwise ANDed with a mask that comprises 1's for each triangle up to the triangle for which M′ is being calculated, which produces a modified X value that always has 0's after that triangle. Then, a population counter instruction counts the number of 1's in that modified value. This count is the number of restarts up to and including that triangle. Then, to obtain the M′ value for that triangle, this number is multiplied by 2 and added to the index of the triangle. This produces the result of adding 3 for each reset and 1 for every other triangle to obtain M′.

To obtain Q′ for triangle i, the topology decompressor 502 performs the following operation. First, a temporary copy of S is made in which all entries after i have a S value of 0. This modified temporary copy is called T. Then, the function “firstbighthigh” is applied to T, which produces the index of the highest entry that is equal to 1. Q′ is set to this index, as this is the index where the last code change has occurred.

Determination of V0, V1, and V2 are calculated in a similar manner as with in FIG. 7. Further, calculation of the values for the ear triangles (e.g., triangles before a backtrack triangles, which are triangles 10, 13, and 15 in FIG. 8) occurs in a similar manner as with respect to FIG. 7.

All operations described above, which include calculation of the intermediate data sets 802(1)-802(9) can be performed by representing all values of a data set 802 in a single register and performing associated operations on that register. More specifically, in such examples, each element of a data set 802 is represented as a set of one or more bits and these bits are packed together into a register to form the data set 802. In addition, decompression can occur for multiple triangles in parallel by performing these operations for each triangle in parallel. Many calculations have the same value regardless of which triangle is being decompressed and thus can be reused for each such different triangle.

For the operations of FIG. 8, the following correspondence exists with the steps of FIG. 6: step 602 includes calculating X. Step 604 includes calculating M′ based on X. Step 606 involves calculating Q′, with all intermediate values that Q′ depends on (e.g., C′, P′, S, Y, and B). Step 608 is performed in a similar manner as with FIG. 7 (described above).

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the auxiliary devices 106, the accelerated processing device 116, IO devices 117, the command processor 136, the graphics processing pipeline 134, the compute units 132, the parallel processing units 138, each element of the graphics processing pipeline 134 (e.g., input assembler stage 302, vertex shader stage 304, hull shader stage 306, tessellator stage 308, domain shader stage 310, geometry shader stage 312, rasterizer stage 314, pixel shader stage 316, output merger stage 318, amplification shader stage 313.1, or mesh shader stage 313.2), the topology decompressor 502, or the vertex generator 504 may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for performing rendering operations, the method comprising:
decompressing a compressed topology block to obtain vertex indices for a triangle of a set of triangles, wherein the decompressing includes:
determining a highest index for the triangle based on the compressed topology block,
determining a lowest index for the triangle based on the compressed topology block, and
determining all indices for the triangle based on the highest index, the lowest index, and a code history of the compressed topology block; and
rendering the triangle based on the vertex indices.

2. The method of claim 1, wherein determining the highest index includes determining a number of new indices introduced with each triangle up to the triangle.

3. The method of claim 2, wherein each triangle that comprises a reset triangle introduces three new indices and each other triangle introduces one new index.

4. The method of claim 2, wherein determining the highest index includes calculating a sum of the number of new indices introduced, up to the triangle.

5. The method of claim 1, wherein determining the highest index comprises summing an index of the triangle with double a number of reset triangles up to the triangle.

6. The method of claim 1, wherein determining the lowest index includes subtracting a bias from the highest index.

7. The method of claim 6, wherein the bias is based on whether a code changes occurs.

8. The method of claim 7, wherein a determination of whether the code change occurs is between adjacent triangles in the set, skipping triangles immediately before a backtrack triangle.

9. The method of claim 1, wherein rendering the triangle includes obtaining vertex information based on indices of the triangle.

10. A system for performing rendering operations, the system comprising:
a memory configured to store a compressed topology block; and
a processor configured to perform operations comprising:
decompressing the compressed topology block to obtain vertex indices for a triangle of a set of triangles, wherein the decompressing includes:
determining a highest index for the triangle based on the compressed topology block,
determining a lowest index for the triangle based on the compressed topology block, and
determining all indices for the triangle based on the highest index, the lowest index, and a code history of the compressed topology block; and
rendering the triangle based on the vertex indices.

11. The system of claim 10, wherein determining the highest index includes determining a number of new indices introduced with each triangle up to the triangle.

12. The system of claim 11, wherein each triangle that comprises a reset triangle introduces three new indices and each other triangle introduces one new index.

13. The system of claim 11, wherein determining the highest index includes calculating a sum of the number of new indices introduced, up to the triangle.

14. The system of claim 10, wherein determining the highest index comprises summing an index of the triangle with double a number of reset triangles up to the triangle.

15. The system of claim 10, wherein determining the lowest index includes subtracting a bias from the highest index.

16. The system of claim 15, wherein the bias is based on whether a code changes occurs.

17. The system of claim 16, wherein a determination of whether the code change occurs is between adjacent triangles in the set, skipping triangles immediately before a backtrack triangle.

18. The system of claim 10, wherein rendering the triangle includes obtaining vertex information based on indices of the triangle.

19. A non-transitory computer-readable medium storing instructions that, when executed by a processor, cause the processor to perform operations comprising:
decompressing a compressed topology block to obtain vertex indices for a triangle of a set of triangles, wherein the decompressing includes:
determining a highest index for the triangle based on the compressed topology block,
determining a lowest index for the triangle based on the compressed topology block, and
determining all indices for the triangle based on the highest index, the lowest index, and a code history of the compressed topology block; and
rendering the triangle based on the vertex indices.

20. The non-transitory computer-readable medium of claim 19, wherein determining the highest index includes determining a number of new indices introduced with each triangle up to the triangle.
